(19) United States
(12) Patent Application Publication
(10) Pub. No.: US 2004/0073799 A1
(43) Pub. Date: Apr. 15, 2004

(54) Method for loading a software program onto a mobile communication terminal

(76) Inventors: Hans-Joachim Hitz, Strasslach-Dingharting (DE); Jorg Kunstner, Munchen (DE); Markus Riedinger, Oberschleissheim (DE); Leif Sillge, Rathenow (DE)

Correspondence Address: Bell, Boyd & Lloyd LLC, P.O. Box 1135, Chicago, IL, 60690-1135, US

(21) Appl. No.: 10/401,661

(22) Filed: Mar. 28, 2003

(30) Foreign Application Priority Data
Mar. 28, 2002 (EP) 02007195.7

(51) Int. Cl. H04L 9/00

(52) U.S. Cl. 713/176; 380/270

(57) ABSTRACT

A method is provided for loading a data stream for a software program from a program source onto a communication terminal, having the following steps: the data stream for the software program is split into a number of successive data blocks; a respective data block attribute is generated for at least two of the data blocks using a first mathematical one-way function; an overall attribute for the data stream is generated from the at least two data block attributes using a second mathematical one-way function; a digital signature is generated from the overall attribute using a secret key belonging to the program source; the signature and the at least two data block attributes are transmitted to the mobile communication terminal; the signature is verified by the mobile communication terminal using a public key which is stored in the communication terminal and is associated with the secret key belonging to the program source; and the software program is loaded onto the mobile communication terminal if the verification has led to a positive result.

### BACKGROUND OF THE INVENTION

The present invention relates to a method for loading a data stream for a software program from a program source onto a mobile communication terminal.

Methods of the above-mentioned type require the integrity of the software program to be ensured for a microcontroller system in a communication terminal. The technical integrity (i.e., the verification of whether the software program has been transferred correctly to the communication terminal), can be established in a comparatively simple manner using checksums. Such checksums are not sufficient, however, to satisfy security-related aspects of loading the software program onto the mobile communication terminal. Software programs which are already present on the communication terminal can be manipulated in order, by way of example, to change internal SIM lock codings or to spy out data which are on the mobile communication terminal.

In addition, trouble-free operation of the software program can be ensured for the communication terminal only if the software program is a software program which has been checked and passed by the manufacturer.

To date, attempts have been made to ensure the integrity of a software program from a security-related point of view by restricting the loading of the software program, particularly also the loading of an updated version of a software program which is already on the mobile communication terminal, to being performed at familiar points, such as sales points, service points and the like for mobile communication terminals.

No provision has been made to date for the user himself/herself to load a software program onto a mobile communication terminal. However, it has been found to be necessary to improve the checkability of the software program's integrity of origin, since it cannot necessarily be assumed that people who have access to the necessary know-how or necessary tools also manipulate software programs, change origin codings or perform similar actions.

Against this background, the present invention is directed toward a method for loading a data stream for a software program from a program source onto a mobile communication terminal which takes better account of the aspect of integrity of origin.

### SUMMARY OF THE INVENTION

The object is achieved by a method for loading a data stream for a software program from a program source onto a mobile communication terminal, having the following steps:

a) the data stream for the software program is split into a number of successive data blocks;

b) a respective data block attribute is generated for at least two of the data blocks using a first mathematical one-way function;

c) an overall attribute for the data stream is generated from the at least two data block attributes using a second mathematical one-way function;

d) a digital signature is generated from the overall attribute using a secret key belonging to the program source;

e) the signature and the at least two data block attributes are transmitted to the mobile communication terminal;

f) the signature is verified by the mobile communication terminal using a public key which is stored in the communication terminal and is associated with the secret key belonging to the program source; and

g) the software program is loaded onto the mobile communication terminal if the verification in step f) has led to a positive result.

A significant feature of the method is that the data stream for the software program, which also can be, in particular, an updated version of a software program which is already on the mobile communication terminal, can have a digital signature impressed into it which can be checked by the mobile communication terminal.

In the simplest case, the overall attribute generated is based on two data block attributes which can depict either just some of the data stream or the entire data stream. It is advantageous if both the data block attributes and their position in the data stream are put into the overall attribute generated.

The signature can be verified by the mobile communication terminal by virtue of the overall attribute recovered via the public key being compared with an attribute for the at least two data blocks, which is likewise obtained using the second mathematical one-way function. In this way, the origin of the at least two data blocks and their incorruption are verified. One advantage which can be found is that the signature verification can be performed by the actual transmission of the data stream, irrespective of the method chosen.

If the two data blocks form just some of the entire data stream for the software program, the verification is restricted to this extent. As such, the remaining data blocks of the data stream are not certain to be incorrupt. The degree to which the data blocks for which data block attributes are generated cover the entire data stream depends on the degree of certainty desired when verifying the data stream. The decision about whether or not a particular data stream section is security-related is preferably taken by a piece of software in the mobile communication terminal.

The software program is loaded onto the mobile communication terminal or its microcontroller system only if verification of the signature has resulted in a positive result, wherein the data stream, which is preferably transferred to the mobile communication terminal after the digital signature has been transmitted, remains on the program source if the verification in step f) returns a negative result.

As compared with the prior art, the inventive method has the advantage of increased security because a modified software program or a software program which is set up to spy out data cannot be loaded onto the mobile communication terminal in the absence of a correct digital signature.

It is regarded as preferable that in step g), data block attributes for the at least two data blocks are additionally calculated by the mobile communication terminal using the first mathematical one-way function, the two data block attributes obtained in this manner are checked for a match with the data block attributes transmitted in step e), and loading of the software can be terminated if the check is negative for at least one of the data blocks. To be more precise, data which have already been loaded onto the mobile communication terminal are rejected if the result is negative, with either just the data block in question being rejected or the loading of the software being terminated altogether.

In this way, when the signature has been successfully verified, the individual data blocks can be successively checked for incorruption when the data stream is transmitted, with verification of the individual data block attributes being ensured on the basis of the digital signature.

The check on one of the data block attributes can be performed immediately after reception of the associated data block and, if a check returns a negative result, the loading operation is terminated and any data stream parts which already have been loaded from earlier data blocks are removed from the mobile communication terminal again.

Any of the embodiments of the inventive method which have been explained above can be carried out independently of the mobile communication terminal itself, and both an entire piece of software for the mobile communication terminal and individual software areas can be modified or exchanged.

The data stream for the software program also can be provided with multiple signatures using one preferred embodiment of the inventive method, namely if, by way of example, in step d), further secret keys belonging to the program source are used to generate a number of digital signatures on the basis of the overall attribute generated in step c), and the public keys associated with the secret keys are stored in the mobile communication terminal.

The mobile communication terminal also can store just a subset of the public keys associated with the secret keys. In one embodiment of the terminal, a pair including a secret key and a public key is associated with a version of the software program, particularly an update version. In this way, the operator of the program source can use allocation of the public key in order to stipulate which mobile communication terminals need to be provided with which version of the software program.

For the first and second mathematical one-way functions, a hash function which is well known in the prior art preferably can be used which has the property that the function value obtained cannot be specifically constructed using altered input variables. Although it is also not possible to make inferences about the input values, these are available in plain text.

For the sake of simplicity, the first and second mathematical one-way functions can be identical.

Additional features and advantages of the present invention are described in, and will be apparent from, the following Detailed Description of the Invention and the Figures.

### BRIEF DESCRIPTION OF THE FIGURES

FIG. 1 schematically illustrates the sequence of a method for loading a software program onto a mobile communication terminal in accordance with the teachings of the present invention.

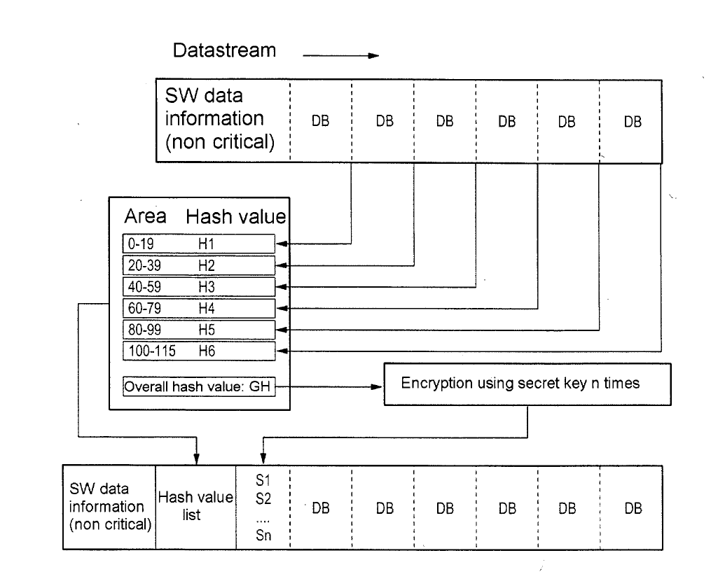

### DETAILED DESCRIPTION OF THE INVENTION

The description of the method based on the present invention is started by considering the structure of the software program which is to be loaded from a program source onto a mobile communication terminal. The data stream is split into individual data blocks following one another, whose size can be selected as desired. The data stream is extended by software data information which can be regarded as noncritical from a security point of view. The manufacturer of the software program uses a respective mathematical one-way function, namely a hash function, to calculate, for the individual data blocks DB, hash values for the respective data blocks.

Thus, in the exemplary embodiment shown, the software program data elements 0-19 have an associated first hash value H1, the software program data elements 20-39 have an associated second hash value H2, etc., with the sixth data block having a reduced number of software program data elements as compared with the preceding data blocks.

Using the same hash function as was used to calculate the hash values H1, H2, . . . , the overall attribute calculated is an overall hash value GH for the hash values obtained H1, H2, etc. The overall hash value GH is encrypted a number of times by the program source using secret keys, the exemplary embodiment involving the use of n secret keys belonging to the program source. In this way, n digital signatures S₁, S₂, . . . , and Sₙ are generated on the basis of the overall hash value GH.

The public keys associated with the secret keys have been stored fully or partially in the mobile communication terminal beforehand.

The actual loading of the software onto a microcontroller system in the mobile communication terminal is now effected as follows. To start, noncritical software data information is transferred, which is followed by a list of the hash values H1, H2, . . . . Next, one or more of the digital signatures respectively associated with the overall hash value GH and with one of the n secret keys are transferred to the mobile communication terminal. If a number of digital signatures are transferred, multiple signing of the list of hash values H1, H2, . . . is involved.

In the attempt, it is possible either to use a piece of external software to select the signatures which are to be used or else to transmit all the signatures to the communication terminal, which then selects the suitable signature. Generally, multiple signing is involved if there is more than one signature in a source file.

Provided that just one digital signature is selected from the n digital signatures, a single digital signature is involved. In this case, this digital signature can be associated with a particular version of the software program, wherein the digital signature is used to select a version of the software program. In this case, the software program is loaded onto the mobile communication terminal only if the secret key on which the digital signature is based is part of a key pair whose public key is stored in the mobile communication terminal. This allows the manufacturer of the software program to exclude a particular portion of mobile communication terminals which do not have the necessary public key from particular software program updates, for example.

Following transfer of the at least one digital signature S₁, software in the mobile communication terminal verifies the digital signature S₁ before the data blocks DB are transferred from the program source to the mobile communication terminal. Provided that the public key which matches the digital signature's secret key is available, by way of example, during the manufacturing process for the mobile communication terminal, the encrypted overall hash value GH is decrypted using the public key. A check is then carried out, to determine whether the decrypted overall hash value GH corresponds to an attribute which results from application of the hash function to the list of hash values H1, H2, . . . . In this way, the list of hash values H1, H2, . . . is verified, wherein its incorruption and its origin from the trustworthy program source are certain.

Provided that verification of the at least one digital key S1 has returned a positive result, the data stream starts to be loaded onto the mobile communication terminal. In the negative case, the loading operation is terminated.

With a positively verified digital signature, the individual data blocks DB are successively loaded onto the mobile communication terminal, with reception of each individual data block DB being followed by the hash value for the data elements associated with this data block being ascertained using the hash function and being compared with the associated hash value, for the first data block this is H1. If the result of this comparison is negative, the loading operation for the software program's data stream is immediately interrupted, and data blocks which already have been loaded can be removed from the mobile communication terminal's microcontroller system again.

Provided that a single digital signature for the software program is chosen, the advantage arises that signing with a key pair including a secret key and a public key and verification of the digital signature for the list of hash values H1, H2, . . . need be carried out only once per loading operation. This keeps down the total execution time for the loading operation, which is advantageous specifically with regard to the low computation power of a microcontroller system in a mobile communication terminal.

It also should be emphasized that it is possible to verify the digital signature before the individual data blocks' hash function is executed, wherein memory resources can be saved in the mobile communication terminal, since they are able to be fully available again after the digital signature has been verified.

In particular, it is also possible for a particular area of a memory in the mobile communication terminal to obtain the individual, transferred data blocks DB in succession, wherein by way of example, an updated version of the software program can be installed step by step, specifically with the lowest possible use of the available memory in the mobile communication terminal.

Although the present invention has been described with reference to specific embodiments, those of skill in the art will recognize that changes may be made thereto without departing from the spirit and scope of the present invention as set forth in the hereafter appended claims.

What is claimed is:

1. A method for loading a data stream for a software program from a program source onto a mobile communication terminal, the method comprising the steps of:
splitting the data stream for the software program into a plurality of successive data blocks;
generating a respective data block attribute for at least two of the data blocks using a first mathematical one-way function;
generating an overall attribute for the data stream from the at least two data block attributes using a second mathematical one-way function;
generating a digital signature from the overall attribute using a secret key belonging to the program source;
transmitting the digital signature and the at least two data block attributes to the mobile communication terminal;
verifying the digital terminal by the mobile communication terminal using a public key which is stored in the communication terminal and is associated with the secret key belonging to the program source; and
loading the software program onto the mobile communication terminal if the verification from the step of verifying has led to a positive result.

2. A method for loading a data stream for a software program from a program source onto a mobile communication terminal as claimed in claim 1, wherein the step of loading the software program includes additionally calculating data block attributes for the at least two data blocks by the mobile communication terminal using the first mathematical one-way function, checking the two data block attributes calculated for a match with the data block attributes transmitted in the step of transmitting, and terminating loading of the software if the check is negative for at least one of the data blocks.

3. A method for loading a data stream for a software program from a program source onto a mobile communication terminal as claimed in claim 2, wherein the step of loading the software program includes performing the check on one of the data block attributes immediately after reception of the associated data block.

4. A method for loading a data stream for a software program from a program source onto a mobile communication (terminal as claimed in claim 1, wherein the step of generating the digital signature includes using further secret keys belonging to the program source to generate a plurality of digital signatures based on the overall attribute generated in the step of generating the overall attribute, and storing the public keys associated with the secret keys in the mobile communication terminal.

5. A method for loading a data stream for a software program from a program source onto a mobile communication terminal as claimed in claim 1, wherein the step of generating the digital signatures includes using further secret keys belonging to the program source to generate a plurality of digital signatures based on the overall attribute generated in the step of generating the overall attribute, and storing a subset of the public keys associated with the secret keys in the mobile communication terminal.

6. A method for loading a data stream for a software program from a program source onto a mobile communication terminal as claimed in claim 5, wherein a pair including a secret key and a public key is associated with a version of the software program.

7. A method for loading a data stream for a software program from a program source onto a mobile communication terminal as claimed in claim 1, wherein a respective hash function is used for the first and second mathematical one-way function.

8. A method for loading a data stream for a software program from a program source onto a mobile communication terminal as claimed in claim 1, wherein the first and second mathematical one-way functions are identical.
